(19) United States
(12) Patent Application Publication
(10) Pub. No.: US 2026/0088216 A1
(43) Pub. Date: Mar. 26, 2026

(54) ELECTRONIC COMPONENT

(71) Applicant: TDK Corporation, Tokyo (JP)

(72) Inventors: Masato YAMAGUCHI, Tokyo (JP); Takuya SATO, Tokyo (JP)

(73) Assignee: TDK Corporation, Tokyo (JP)

(21) Appl. No.: 19/317,172

(22) Filed: Sep. 3, 2025

(30) Foreign Application Priority Data
Sep. 24, 2024 (JP) 2024-164917

(51) Int. Cl. H01F 27/42; H01F 27/28; H01F 27/29

(52) U.S. Cl. CPC H01F 27/42; H01F 27/2804; H01F 27/292; H01F 2027/2809

(57) ABSTRACT

An electronic component includes a first main body including a circuit section, and a second main body mounted on the first main body and including a sub-circuit section. The first main body further includes a plurality of electrode pads. The second main body further includes a plurality of terminals. The plurality of electrode pads include a first electrode pad and a second electrode pad. The plurality of terminals include a first terminal connected to the first electrode pad, and a second terminal connected to the second electrode pad. The circuit section is connected to the first electrode pad. The sub-circuit section is connected to the second terminal. A distance between centers of the first electrode pad and the second electrode pad is greater than a distance between centers of the first terminal and the second terminal.

### CROSS-REFERENCE TO RELATED APPLICATION

This application claims the benefit of Japanese Priority Patent Application No. 2024-164917 filed on Sep. 24, 2024, the entire contents of which are incorporated herein by reference.

### BACKGROUND

The disclosure relates to an electronic component including a main body and a mounted component mounted on the main body.

One of electronic components used in a wireless communication system includes filters such as a low-pass filter, a high-pass filter, and a band-pass filter. These filters are configured using a plurality of resonators. As resonators used in these filters, for example, an LC resonator configured using an inductor and a capacitor, and an acoustic wave resonator configured using an acoustic wave element are known. The acoustic wave element is an element using an acoustic wave. Examples of the acoustic wave element include a surface acoustic wave element using a surface acoustic wave and a bulk acoustic wave element using a bulk acoustic wave.

As filter devices, in addition to a filter device configured using only an LC resonator or only an acoustic wave resonator, a filter device configured using an LC resonator and an acoustic wave resonator. In such a filter device, for example, a second main body including the acoustic wave resonator is mounted on a first main body including the LC resonator.

JP 2013-33947 A discloses a technology in which an electronic component including a surface acoustic wave element is implemented on a wiring substrate. In JP 2013-33947 A, a terminal of the electronic component and a pad electrode of the wiring substrate are electrically and mechanically connected to each other by a bonding material such as solder.

In recent years, the market has been demanding downsizing and more space-saving of compact mobile communication apparatuses, and there is also a demand for downsizing of branching filters used in the communication apparatuses. As the technology disclosed in JP 2013-33947 A, in the electronic component in which the second main body is mounted on the first main body, a plurality of electrode pads of the first main body and a plurality of terminals of the second main body are connected by the bonding material. If the electronic component is downsized, not only distances between a plurality of elements of the electronic component but also distances between the plurality of electrode pads of the first main body, between the plurality of terminals of the second main body, and the like, become smaller. As a result, unintended coupling or floating capacitance may occur, and the desired characteristics could not be obtained in some cases.

In order to suppress the unintended coupling or floating capacitance, devises of some kind are necessary not only for shapes and layouts of the plurality of elements, but also for the plurality of electrode pads and the plurality of terminals. However, devises for the plurality of electrode pads and the plurality of terminals have not been sufficiently considered in the past.

The above problem applies not only when the second main body includes the acoustic wave resonator but also when the second main body includes elements other than the acoustic wave resonator.

### SUMMARY

An electronic component according to one embodiment of the disclosure includes a first main body including a plurality of dielectric layers stacked together, and a circuit section; a second main body mounted on the first main body, and including a sub-circuit section; and a first filter including at least one of the circuit section or the sub-circuit section, and configured to selectively pass a signal of a frequency within a first passband. The first main body further includes a first surface and a second surface located at both ends of the plurality of dielectric layers in a stacking direction of the plurality of dielectric layers, and a plurality of electrode pads provided on the first surface. The second main body further includes a plurality of terminals provided on an outer surface of the second main body. The plurality of electrode pads include a first electrode pad and a second electrode pad. The plurality of terminals include a first terminal connected to the first electrode pad, and a second terminal connected to the second electrode pad. The circuit section is connected to the first electrode pad, and the sub-circuit section is connected to the second terminal. A distance between centers of the first electrode pad and the second electrode pad is greater than a distance between centers of the first terminal and the second terminal.

Objects, features, and advantages of the disclosure will appear more fully from the following description.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the technology.

FIG. 1 is a block diagram showing a configuration of an electronic component according to an example embodiment of the disclosure.

FIG. 2 is a perspective view showing the electronic component according to the example embodiment of the disclosure.

FIG. 3 is a perspective view showing a first main body in the example embodiment of the disclosure.

FIG. 4 is a plan view showing the first main body in the example embodiment of the disclosure.

FIG. 5 is a plan view showing a part inside the first main body in the example embodiment of the disclosure.

FIG. 6 is a perspective view showing a part inside the first main body in the example embodiment of the disclosure.

FIG. 7 is a plan view showing first to fourth electrode pads and first to fourth terminals in the example embodiment of the disclosure.

FIG. 8 is a circuit diagram showing a circuit configuration in a model of an example used in a simulation.

FIG. 9 is a plan view showing first to fourth electrode pads and first to fourth terminals in an electronic component of a comparative example.

FIG. 10 is a characteristic chart showing frequency characteristics of isolation of each model determined by the simulation.

FIG. 11 is a plan view showing first to fourth electrode pads and first to fourth terminals in a first modification example.

FIG. 12 is a plan view showing first to fourth electrode pads and first to fourth terminals in a second modification example.

### DETAILED DESCRIPTION

An object of the disclosure is to provide an electronic component that includes a main body and a mounted component mounted on the main body, and is capable of achieving desired characteristics while downsizing the electronic component.

In the following, some example embodiments and modification examples of the technology are described in detail with reference to the accompanying drawings. Note that the following description is directed to illustrative examples of the disclosure and not to be construed as limiting the technology. Factors including, without limitation, numerical values, shapes, materials, components, positions of the components, and how the components are coupled to each other are illustrative only and not to be construed as limiting the technology. Further, elements in the following example embodiments which are not recited in a most-generic independent claim of the disclosure are optional and may be provided on an as-needed basis. The drawings are schematic and are not intended to be drawn to scale. Like elements are denoted with the same reference numerals to avoid redundant descriptions.

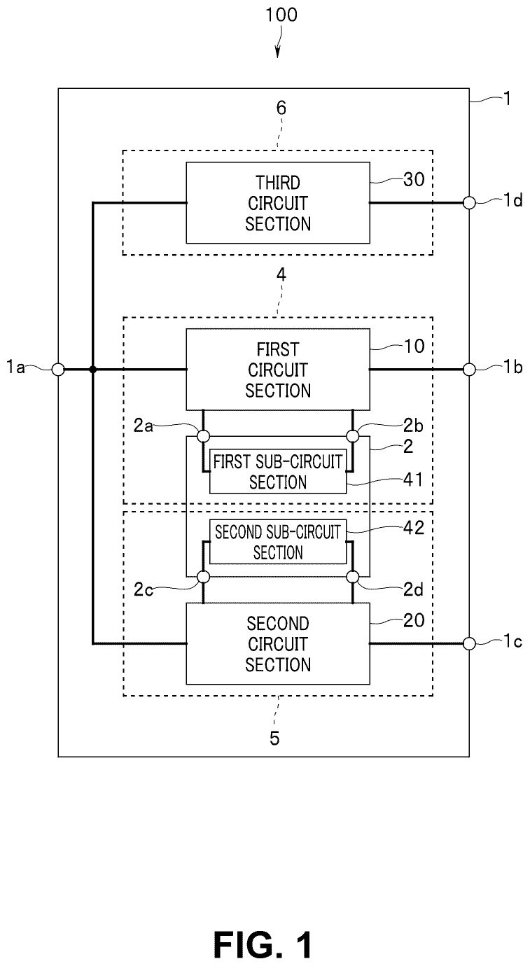

Initially, a schematic configuration of an electronic component 100 according to an example embodiment of the disclosure will be described with reference to FIG. 1. FIG. 1 is a block diagram showing a configuration of the electronic component 100.

The electronic component 100 according to the example embodiment is a branching filter (triplexer) including a first filter 4, a second filter 5, and a third filter 6. The first filter 4 is configured to selectively pass a first signal of a frequency within a first passband. The second filter 5 is configured to selectively pass a second signal of a frequency within a second passband different from the first passband. The third filter 6 is configured to selectively pass a third signal of a frequency within a third passband different from each of the first passband and the second passband. In the example embodiment, in particular, the second passband is a frequency band higher than the first passband, and the third passband is a frequency band lower than the first passband.

The first filter 4 includes a first circuit section 10. The second filter 5 includes a second circuit section 20. The third filter 6 includes a third circuit section 30. Each of the first to third circuit sections 10, 20, and 30 is an LC circuit including at least one inductor and at least one capacitor.

The first filter 4 further includes a first sub-circuit section 41. The second filter 5 further includes a second sub-circuit section 42. The first circuit section 10 is connected to the first sub-circuit section 41. The second circuit section 20 is connected to the second sub-circuit section 42. The first and second sub-circuit sections 41 and 42 are electrically separated from each other. The first and second sub-circuit sections 41 and 42 each include at least one acoustic wave element. Examples of the acoustic wave element may include, for example, a bulk acoustic wave element and a surface acoustic wave element. Each of the first and second sub-circuit sections 41 and 42 may be an acoustic wave resonator.

The first circuit section 10 and the first sub-circuit section 41 constitute one filter circuit (first filter 4). The second circuit section 20 and the second sub-circuit section 42 constitute another filter circuit (second filter 5).

The electronic component 100 further includes a common terminal 1a, a first signal terminal 1b, a second signal terminal 1c, and a third signal terminal 1d. The first filter 4 is connected to the first signal terminal 1b and is provided between the common terminal 1a and the first signal terminal 1b in a circuit configuration. The second filter 5 is connected to the second signal terminal 1c and is provided between the common terminal 1a and the second signal terminal 1c in the circuit configuration. The third filter 6 is connected to the third signal terminal 1d and is provided between the common terminal 1a and the third signal terminal 1d in the circuit configuration. Note that in the present application, the expression “in the (a) circuit configuration” is used to indicate not layout in the physical configuration but layout in the circuit diagram.

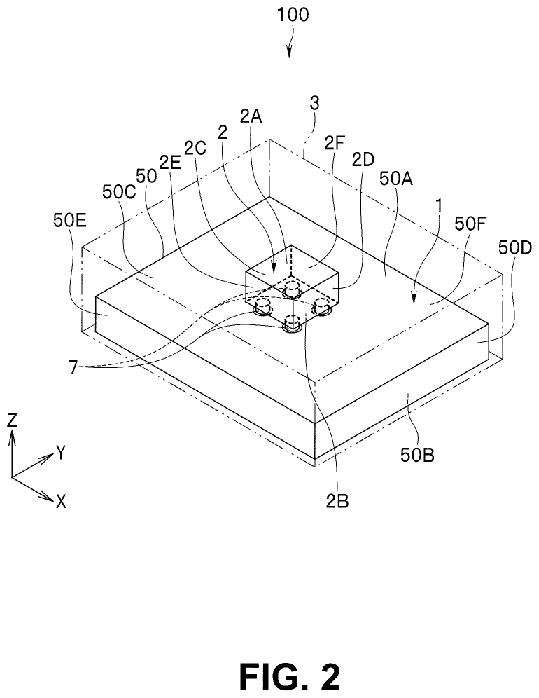

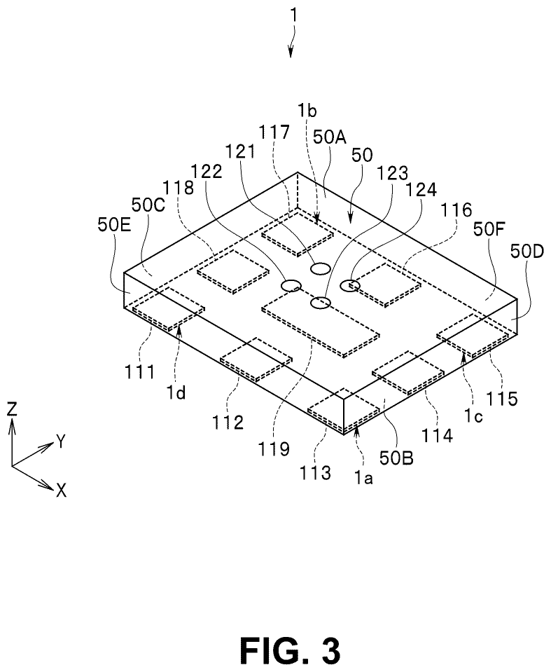

Next, the configuration of the electronic component 100 will be specifically described with reference to FIG. 1 to FIG. 3. FIG. 2 is a perspective view showing the electronic component 100. FIG. 3 is a perspective view showing a first main body in the example embodiment. As shown in FIG. 2, the electronic component 100 includes a first main body 1, a second main body 2 mounted on the first main body 1, and a sealing portion 3 that seals the first and second main bodies 1 and 2. The sealing portion 3 is formed of a resin, for example.

The first main body 1 includes the first to third circuit sections 10, 20, and 30 shown in FIG. 1. The first main body 1 also includes a stack 50. The stack 50 includes a plurality of dielectric layers stacked together, and a plurality of conductor layers and a plurality of through holes formed on/in the plurality of dielectric layers. The LC circuits of the respective first to third circuit sections 10, 20, and 30 are configured using the plurality of dielectric layers, the plurality of conductor layers, and the plurality of through holes.

The plurality of through holes are formed by filling holes for forming respective through holes with a conductive paste. Each of the plurality of through holes is connected to an electrode, a conductor layer, or another through hole.

The stack 50 includes a first surface 50A and a second surface 50B located at both ends of the plurality of dielectric layers in a stacking direction, and four side surfaces 50C to 50F connecting the first and second surfaces 50A and 50B. The side surfaces 50C and 50D are directed opposite to each other, and the side surfaces 50E and 50F are also directed opposite to each other. The side surfaces 50C to 50F are perpendicular to the first and second surfaces 50A and 50B.

Here, an X direction, a Y direction, and a Z direction will be defined as shown in FIG. 2 and FIG. 3. The X, Y, and Z directions are orthogonal to one another. In the example embodiment, a direction parallel to the stacking direction will be referred to as the Z direction. The Z direction is also a direction parallel to a direction in which the first and second main bodies 1 and 2 are arranged. A direction opposite to the X direction will be referred to as a −X direction, a direction opposite to the Y direction as a −Y direction, and a direction opposite to the Z direction as a −Z direction. The expression “when seen in a predetermined direction (the stacking direction, for example)” means that the intended object is seen from a position away in the predetermined direction or a direction parallel to the predetermined direction.

As shown in FIG. 3, the first surface 50A is located at the end of the stack 50 in the Z direction. The first surface 50A is also a part of outer surfaces of the first main body 1 on which the second main body 2 is mounted, and is a top surface of the stack 50. The second surface 50B is located at the end of the stack 50 in the −Z direction. The second surface 50B is a surface opposite to the first surface 50A, and is also a bottom surface of the stack 50. The side surface 50C is located at the end of the stack 50 in the −X direction. The side surface 50D is located at the end of the stack 50 in the X direction. The side surface 50E is located at the end of the stack 50 in the −Y direction. The side surface 50F is located at the end of the stack 50 in the Y direction.

The first main body 1 further includes a plurality of electrodes 111, 112, 113, 114, 115, 116, 117, 118, and 119 provided on the second surface 50B of the stack 50. The electrode 111 is disposed near the corner that exists at a position where the second surface 50B, the side surface 50C, and the side surface 50E intersect. The electrode 113 is disposed near the corner that exists at a position where the second surface 50B, the side surface 50D, and the side surface 50E intersect. The electrode 115 is disposed near the corner that exists at a position where the second surface 50B, the side surface 50D, and the side surface 50F intersect. The electrode 117 is disposed near the corner that exists at a position where the second surface 50B, the side surface 50C, and the side surface 50F intersect.

The electrode 112 is disposed between the electrodes 111 and 113. The electrode 114 is disposed between the electrodes 113 and 115. The electrode 116 is disposed between the electrodes 115 and 117. The electrode 118 is disposed between the electrodes 111 and 117. The electrode 119 is disposed at the center or at substantially the center of the second surface 50B.

The first main body 1 further includes the common terminal 1a, the first signal terminal 1b, the second signal terminal 1c, and the third signal terminal 1d shown in FIG. 1. The electrode 111 corresponds to the third signal terminal 1d, the electrode 113 corresponds to the common terminal 1a, the electrode 115 corresponds to the second signal terminal 1c, and the electrode 117 corresponds to the first signal terminal 1b. The common terminal 1a and the first to third signal terminals 1b to 1d are thus provided on the second surface 50B of the stack 50. Each of the electrodes 112, 114, 116, 118, and 119 is connected to the ground.

The first main body 1 further includes a plurality of electrode pads provided on the first surface 50A of the stack 50. In the example embodiment, the plurality of electrode pads include a first electrode pad 121, a second electrode pad 122, a third electrode pad 123, and a fourth electrode pad 124. The first to fourth electrode pads 121 to 124 may be disposed near the center of the first surface 50A. The first and second electrode pads 121 and 122 are arranged in this order in the −Y direction. The third and fourth electrode pads 123 and 124 are arranged in this order in the Y direction at positions on the X direction side relative to the first and second electrode pads 121 and 122.

The second main body 2 includes the first and second sub-circuit sections 41 and 42. Moreover, the second main body 2 includes a third surface 2A and a fourth surface 2B located at both ends in the direction parallel to the Z direction, and four side surfaces 2C to 2F connecting the third and fourth surfaces 2A and 2B. The side surfaces 2C and 2D are directed opposite to each other, and the side surfaces 2E and 2F are also directed opposite to each other. The side surfaces 2C to 2F are perpendicular to the third and fourth surfaces 2A and 2B.

As shown in FIG. 2, the third surface 2A is located at the end of the second main body 2 in the Z direction. The third surface 2A is also a top surface of the second main body 2. The fourth surface 2B is located at the end of the second main body 2 in the −Z direction. The fourth surface 2B is a surface facing the first main body 1, and is also a bottom surface of the second main body 2. The side surface 2C is located at the end of the second main body 2 in the −X direction. The side surface 2D is located at the end of the second main body 2 in the X direction. The side surface 2E is located at the end of the second main body 2 in the −Y direction. The side surface 2F is located at the end of the second main body 2 in the Y direction.

The second main body 2 further includes a plurality of terminals disposed on the fourth surface 2B of the second main body 2. In the example embodiment, the plurality of terminals include a first terminal 2a, a second terminal 2b, a third terminal 2c, and a fourth terminal 2d. The first terminal 2a is disposed near the corner that exists at a position where the fourth surface 2B, the side surface 2C, and the side surface 2F intersect. The second terminal 2b is disposed near the corner that exists at a position where the fourth surface 2B, the side surface 2C, and the side surface 2E intersect. The third terminal 2c is disposed near the corner that exists at a position where the fourth surface 2B, the side surface 2D, and the side surface 2E intersect. The fourth terminal 2d is disposed near the corner that exists at a position where the fourth surface 2B, the side surface 2D, and the side surface 2F intersect.

The first sub-circuit section 41 is provided between the first and second terminals 2a and 2b in the circuit configuration, and is connected to the first terminal 2a and the second terminal 2b. The second sub-circuit section 42 is provided between the third and fourth terminals 2c and 2d in the circuit configuration, and is connected to the third terminal 2c and the fourth terminal 2d.

In the state where the second main body 2 is mounted on the first main body 1, the first to fourth terminals 2a, 2b, 2c, and 2d of the second main body 2 respectively face the first to fourth electrode pads 121, 122, 123, and 124 of the first main body 1.

The first to fourth terminals 2a, 2b, 2c, and 2d are respectively connected to the first to fourth electrode pads 121, 122, 123, and 124 via a conductive bonding material. In the example embodiment, in particular, the first to fourth terminals 2a, 2b, 2c, and 2d are electrically and physically connected respectively to the first to fourth electrode pads 121, 122, 123, and 124 by a solder bump 7, for example.

The first electrode pad 121, the second electrode pad 122, the first terminal 2a, and the second terminal 2b are connected to the first signal terminal 1b. The third electrode pad 123, the fourth electrode pad 124, the third terminal 2c, and the fourth terminal 2d are connected to the second signal terminal 1c.

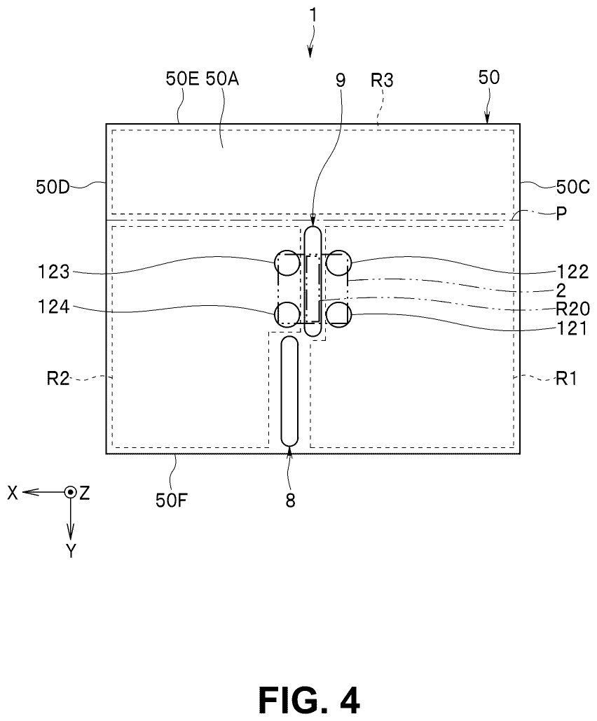

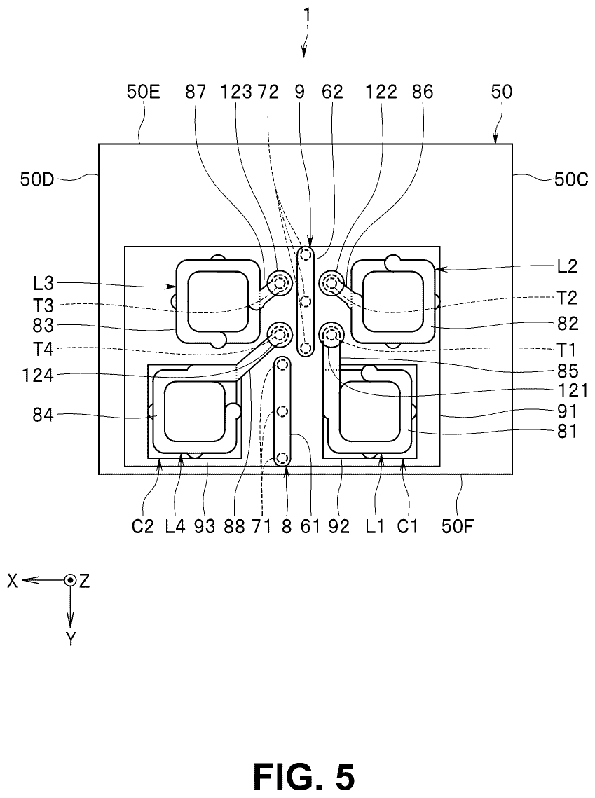

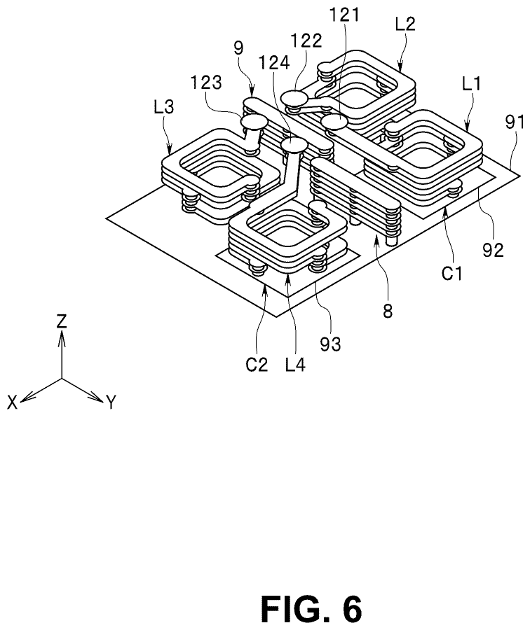

Next, the first main body 1 will be described in more detail with reference to FIG. 4 to FIG. 6. FIG. 4 is a plan view showing the first main body 1. FIG. 5 is a plan view showing a part inside the first main body 1. FIG. 6 is a perspective view showing a part inside the first main body 1.

The first main body 1 further includes a first structure 8 and a second structure 9 each connected to the ground. The second structure 9 is disposed between the first electrode pad 121 and the fourth electrode pad 124 and between the second electrode pad 122 and the third electrode pad 123 when seen in the Z direction. The first and second electrode pads 121 and 122 are disposed forward of the second structure 9 in the −X direction when seen in the Z direction. The third and fourth electrode pads 123 and 124 are disposed forward of the second structure 9 in the X direction when seen in the Z direction. The first structure 8 is disposed between the second structure 9 and the side surface 50F.

Here, a three-dimensional region within the stack 50 defined by the first and second structures 8 and 9 and a boundary surface P will be described with reference to FIG. 4. The boundary surface P is an imaginary plane parallel to an XZ plane and located between the first and second structures 8 and 9 and the side surface 50E. The boundary surface P may be located closer to the second structure 9 than to the side surface 50E.

The stack 50 includes a first region R1, a second region R2, and a third region R3. The first region R1 is a region surrounded by the first and second structures 8 and 9, the side surfaces 50C and 50F, and the boundary surface P. The second region R2 is a region surrounded by the first and second structures 8 and 9, the side surfaces 50D and 50F, and the boundary surface P. The third region R3 is a region surrounded by the side surfaces 50C, 50D, and 50E and the boundary surface P. In FIG. 4, a region surrounded by a broken line denoted by the reference sign R1 indicates the first region R1, a region surrounded by a broken line denoted by the reference sign R2 indicates the second region R2, and a region surrounded by a broken line denoted by the reference sign R3 indicates the third region R3. The first and second structures 8 and 9 are used as partitioning portions to partition the first region R1 and the second region R2.

The first region R1 is a region including at least a part of the first circuit section 10 but not including the second circuit section 20. The second region R2 is a region including at least a part of the second circuit section 20 but not including the first circuit section 10. The third region R3 is a region including the third circuit section 30. The third region R3 may or does not have to include another part of the first circuit section 10 and another part of the second circuit section 20.

Next, structures of the first and second structures 8 and 9 will be described with reference to FIG. 5 and FIG. 6. The first structure 8 includes a plurality first through holes 71, and a plurality of first conductor layers 61 electrically connected to the plurality of first through holes 71. The plurality of first conductor layers 61 are disposed at different positions from each other in the direction parallel to the stacking direction, that is, the Z direction. The second structure 9 includes a plurality of second through holes 72, and a plurality of second conductor layers 62 electrically connected to the plurality of second through holes 72. The plurality of second conductor layers 62 are disposed at different positions from each other in the direction parallel to the stacking direction, that is, the Z direction.

Each of the plurality of first conductor layers 61 and the plurality of second conductor layers 62 includes a part extending along the same direction orthogonal to the stacking direction. In the example embodiment, in particular, each of the plurality of first conductor layers 61 and the plurality of second conductor layers 62 extends as a whole along a direction parallel to the Y direction.

In addition, the shapes of the plurality of first conductor layers 61 are the same as one another. The positions of the plurality of first conductor layers 61 are the same except for their positions in the stacking direction. Two first conductor layers 61 adjacent to each other at a distance in the stacking direction are connected to each other by at least one first through hole 71. In the example shown in FIG. 5 and FIG. 6, the above two first conductor layers 61 are connected to each other by three first through holes 71.

In addition, the shapes of the plurality of second conductor layers 62 are the same as one another. The positions of the plurality of second conductor layers 62 are the same except for their positions in the stacking direction. Two second conductor layers 62 adjacent to each other at a distance in the stacking direction are connected to each other by at least one second through hole 72. In the example shown in FIG. 5 and FIG. 6, the above two second conductor layers 62 are connected to each other by three second through holes 72.

The plurality of first conductor layers 61 include a specific first conductor layer 61. The specific first conductor layer 61 may be, for example, a conductor layer closest to the first surface 50A of the plurality of first conductor layers 61. Since the plurality of first conductor layers 61 are components of the first structure 8, it can be said that the first structure 8 includes the specific first conductor layer 61. In FIG. 5, the reference sign 61 indicates the specific first conductor layer 61.

The plurality of second conductor layers 62 include a specific second conductor layer 62. The specific second conductor layer 62 may be, for example, a conductor layer closest to the first surface 50A of the plurality of the second conductor layers 62. Since the plurality of second conductor layers 62 are components of the second structure 9, it can be said that the second structure 9 includes the specific second conductor layer 62. In FIG. 5, the reference sign 62 indicates the specific second conductor layer 62.

The specific first conductor layer 61 and the specific second conductor layer 62 are located between the first region R1 and the second region R2, and between the first circuit section 10 and the second circuit section 20, when seen in the stacking direction (the direction parallel to the Z direction). As shown in FIG. 5, the specific first conductor layer 61 is not directly connected to the specific second conductor layer 62.

In the example embodiment, in particular, the above description of the specific first conductor layer 61 applies to the first conductor layers 61 other than the specific first conductor layer 61. Similarly, the above description of the specific second conductor layer 62 applies to the second conductor layers 62 other than the specific second conductor layer 62. The first conductor layers 61 are not directly connected to the second conductor layers 62 located at the same position in the stacking direction.

Next, features of the first and second structures 8 and 9 and the first and second circuit sections 10 and 20 will be described with reference to FIG. 4 to FIG. 6. Each of the first and second circuit sections 10 and 20 includes at least one inductor and at least one capacitor. In the example embodiment, the first circuit section 10 includes inductors L1 and L2 and a capacitor C1. The second circuit section 20 includes inductors L3 and L4 and a capacitor C2.

The inductors L1 and L2 are disposed in the first region R1. The inductor L2 is disposed between the second structure 9 and the side surface 50C. The inductor L1 is disposed between the inductor L2 and the side surface 50F and between the first structure 8 and the side surface 50C.

The inductors L3 and L4 are disposed in the second region R2. The inductor L3 is disposed between the second structure 9 and the side surface 50D. The inductor L4 is disposed between the inductor L3 and the side surface 50F and between the first structure 8 and the side surface 50D.

The first structure 8 is disposed between the inductor L1 and the inductor L4 when seen in the Z direction. The second structure 9 is disposed between the inductor L2 and the inductor L3 when seen in the Z direction.

The capacitor C1 is disposed between the inductor L1 and the second surface 50B. The capacitor C2 is disposed between the inductor L4 and the second surface 50B.

The first main body 1 further includes a ground conductor layer 91 connected to the ground. The ground conductor layer 91 is electrically connected to at least one of the electrodes 112, 114, 116, 118, or 119 that are connected to the ground.

The first and second structures 8 and 9 are connected to the ground conductor layer 91. In the example embodiment, in particular, at least one of the plurality of first through holes 71 and at least one of the plurality of second through holes 72 are connected to the ground conductor layer 91.

The ground conductor layer 91 overlaps at least a part of at least one of the first circuit section 10 or the second circuit section 20 when seen in the Z direction. In the example embodiment, in particular, the ground conductor layer 91 overlaps each of the inductors L1 to L4 entirely when seen in the Z direction.

The first main body 1 further includes capacitor conductor layers 92 and 93 disposed in the stack 50. Each of the capacitor conductor layers 92 and 93 faces the ground conductor layer 91 via at least one dielectric layer. The capacitor C1 includes the ground conductor layer 91, the capacitor conductor layer 92, and the at least one dielectric layer interposed between the ground conductor layer 91 and the capacitor conductor layer 92. The capacitor C2 includes the ground conductor layer 91, the capacitor conductor layer 93, and at least one dielectric layer interposed between the ground conductor layer 91 and the capacitor conductor layer 93. The capacitor conductor layer 92 is disposed between the inductor L1 and the ground conductor layer 91. The capacitor conductor layer 93 is disposed between the inductor L4 and the ground conductor layer 91.

The first main body 1 may further include a third structure (not shown) that separates a part of the first circuit section 10 from a part of the third circuit section 30, and a fourth structure (not shown) that separates a part of the second circuit section 20 from another part of the third circuit section 30. The third and fourth structures may be directly or indirectly connected to the ground conductor layer 91. Furthermore, the third and fourth structures may or do not have to be directly connected to each other.

Next, features of the first and second structures 8 and 9 and the second main body 2 will be described with reference to FIG. 2 to FIG. 5. As described above, the first to fourth terminals 2a, 2b, 2c, and 2d of the second main body 2 are respectively connected to the first to fourth electrode pads 121, 122, 123, and 124 of the first main body 1 via the conductive bonding material. In addition, the second structure 9 is disposed between the first electrode pad 121 and the fourth electrode pad 124 and between the second electrode pad 122 and the third electrode pad 123 when seen in the Z direction. Therefore, the second structure 9 is disposed between the first terminal 2a and the fourth terminal 2d and between the second terminal 2b and the third terminal 2c when seen in the Z direction.

In addition, the first and second electrode pads 121 and 122 are disposed forward of the second structure 9 in the −X direction when seen in the Z direction.

Therefore, the first and second terminals 2a and 2b are disposed forward of the second structure 9 in the −X direction when seen in the Z direction.

Furthermore, the third and fourth electrode pads 123 and 124 are disposed forward of the second structure 9 in the X direction when seen in the Z direction.

Therefore, the third and fourth terminals 2c and 2d are disposed forward of the second structure 9 in the X direction when seen in the Z direction.

As described above, the first sub-circuit section 41 is provided between the first terminal 2a and the second terminal 2b in the circuit configuration. Although not shown in the drawings, at least a part of the first sub-circuit section 41 is disposed forward of the second structure 9 in the −X direction when seen in the Z direction.

In addition, as described above, the second sub-circuit section 42 is provided between the third terminal 2c and the fourth terminal 2d in the circuit configuration.

Although not shown in the drawings, at least a part of the second sub-circuit section 42 is disposed forward of the second structure 9 in the X direction when seen in the Z direction.

In FIG. 4, a rectangular region denoted by the reference sign R20 indicates a region located between the first sub-circuit section 41 and the second sub-circuit section 42 in the second main body 2. The region R20 may be a three-dimensional region or a planar region. In addition, the region R20 may be located between a part of the first sub-circuit section 41 and a part of the second sub-circuit section 42. The specific second conductor layer 62 of the second structure 9 overlaps the region R20 when seen in the Z direction.

As shown in FIG. 4, the second structure 9 may protrude outside the second main body 2, i.e., the Y direction side of the second main body 2 and the −Y direction side of the second main body 2, when seen in the Z direction.

The specific first conductor layer 61 of the first structure 8 does not overlap the region R20 when seen in the Z direction. Note that as long as the requirement that the specific first conductor layer 61 does not overlap the region R20 is satisfied, the first structure 8 may or does not have to overlap the second main body 2 when seen in the Z direction. As shown in FIG. 4, in the example embodiment, the specific first conductor layer 61 of the first structure 8 does not overlap the second main body 2 when seen in the Z direction.

Next, features of the inductors L1 to L4 will be described with reference to FIG. 5 and FIG. 6. The inductor L1 includes at least one inductor conductor layer wound around an axis extending in the direction parallel to the stacking direction such that an opening surrounded by the inductor L1 is formed. Hereinafter, an opening surrounded by the inductor L1 or by the at least one inductor conductor layer of the inductor L1 will be referred to as an opening of the inductor L1. The opening of the inductor L1 is directed to the first surface 50A of the stack 50. In addition, the opening of the inductor L1 is located entirely in the first region R1. Hereinafter, for an inductor other than the inductor L1, an opening surrounded by the inductor or by the at least one inductor conductor layer of the inductor will be referred to as an opening of the inductor.

Similarly, the inductors L2, L3, and L4 each include at least one inductor conductor layer wound around an axis extending in the direction parallel to the stacking direction such that openings surrounded by the inductors L2, L3, and L4 respectively are formed. The openings of the inductors L2, L3, and L4 are directed to the first surface 50A of the stack 50. The opening of the inductor L2 is located entirely in the first region R1. The openings of the inductors L3 and L4 are located entirely in the second region R2.

The inductor L1 includes, as the at least one inductor conductor layer, a plurality of inductor conductor layers 81 disposed at a predetermined distance in the stacking direction. Each of the plurality of inductor conductor layers 81 is wound around an axis extending in the direction parallel to the stacking direction so as to surround the opening of the inductor L1. The first main body 1 further includes a conductor layer 85 connected to a first specific inductor conductor layer 81 closest to the first surface 50A of the plurality of inductor conductor layers 81, and a through hole T1 connecting the conductor layer 85 and the first electrode pad 121. In FIG. 5, the boundary between the first specific inductor conductor layer 81 and the conductor layer 85 is indicated by a dotted line.

The inductor L1 may or does not have to be connected to the capacitor C1. When the inductor L1 is connected to the capacitor C1, the first main body 1 may further include a through hole, not shown, that connects the capacitor conductor layer 92 and a second specific inductor conductor layer 81 closest to the second surface 50B of the plurality of inductor conductor layers 81.

The inductor L2 includes, as the at least one inductor conductor layer, a plurality of inductor conductor layers 82 disposed at a predetermined distance in the stacking direction. Each of the plurality of inductor conductor layers 82 is wound around an axis extending in the direction parallel to the stacking direction so as to surround the opening of the inductor L2. The first main body 1 further includes a conductor layer 86 connected to a first specific inductor conductor layer 82 closest to the first surface 50A of the plurality of inductor conductor layers 82, and a through hole T2 connecting the conductor layer 86 and the second electrode pad 122. In FIG. 5, the boundary between the inductor conductor layer 82 and the conductor layer 86 is indicated by a dotted line.

The inductor L2 may or does not have to be connected to the ground. When the inductor L2 is connected to the ground, the first main body 1 may further include a plurality of through holes, not shown, that connect the ground conductor layer 91 and a second specific inductor conductor layer 82 closest to the second surface 50B of the plurality of inductor conductor layers 82.

The inductor L3 includes, as the at least one inductor conductor layer, a plurality of inductor conductor layers 83 disposed at a predetermined distance in the stacking direction. Each of the plurality of inductor conductor layers 83 is wound around an axis extending in the direction parallel to the stacking direction so as to surround the opening of the inductor L3. The first main body 1 further includes a conductor layer 87 connected to a first specific inductor conductor layer 83 closest to the first surface 50A of the plurality of inductor conductor layers 83, and a through hole T3 connecting the conductor layer 87 and the third electrode pad 123. In FIG. 5, the boundary between the inductor conductor layer 83 and the conductor layer 87 is indicated by a dotted line.

The inductor L3 may or does not have to be connected to the ground. When the inductor L3 is connected to the ground, the first main body 1 may further include a plurality of through holes, not shown, that connect the ground conductor layer 91 and a second specific inductor conductor layer 83 closest to the second surface 50B of the plurality of inductor conductor layers 83.

The inductor L4 includes, as the at least one inductor conductor layer, a plurality of inductor conductor layers 84 disposed at a predetermined distance in the stacking direction. Each of the plurality of inductor conductor layers 84 is wound around an axis extending in the direction parallel to the stacking direction so as to surround the opening of the inductor L4. The first main body 1 further includes a conductor layer 88 connected to a first specific inductor conductor layer 84 closest to the first surface 50A of the plurality of inductor conductor layers 84, and a through hole T4 connecting the conductor layer 88 and the fourth electrode pad 124. In FIG. 5, the boundary between the inductor conductor layer 84 and the conductor layer 88 is indicated by a dotted line.

The inductor L4 may or does not have to be connected to the capacitor C2. When the inductor L4 is connected to the capacitor C2, the first main body 1 may further include a through hole, not shown, that connects the capacitor conductor layer 93 and a second specific inductor conductor layer 84 closest to the second surface 50B of the plurality of inductor conductor layers 84.

The inductor L1 is connected to the first sub-circuit section 41 of the second main body 2 via the conductor layer 85, the through hole T1, the first electrode pad 121, and the first terminal 2a. The inductor L2 is connected to the first sub-circuit section 41 of the second main body 2 via the conductor layer 86, the through hole T2, the second electrode pad 122, and the second terminal 2b. The inductor L3 is connected to the second sub-circuit section 42 of the second main body 2 via the conductor layer 87, the through hole T3, the third electrode pad 123, and the third terminal 2c. The inductor L4 is connected to the second sub-circuit section 42 of the second main body 2 via the conductor layer 88, the through hole T4, the fourth electrode pad 124, and the fourth terminal 2d.

The plurality of inductor conductor layers 81 of the inductor L1, the specific first conductor layer 61, and the plurality of inductor conductor layers 84 of the inductor L4 are arranged in this order along a first direction orthogonal to the stacking direction. In the example embodiment, in particular, the plurality of inductor conductor layers 81, the specific first conductor layer 61, and the plurality of inductor conductor layers 84 are arranged in this order along the X direction. The dimension of the specific first conductor layer 61 in a second direction (the Y direction) orthogonal to each of the stacking direction and the first direction (the X direction) may be larger than the dimension of the opening surrounded by each of the plurality of the inductor conductor layers 81 in the second direction (the dimension in the Y direction) and the dimension of the opening surrounded by each of the plurality of inductor conductor layers 84 in the second direction (the dimension in the Y direction).

In addition, the plurality of inductor conductor layers 82 of the inductor L2, the specific second conductor layer 62, and the plurality of inductor conductor layers 83 of the inductor L3 may be arranged in this order along the first direction orthogonal to the stacking direction. In the example embodiment, in particular, the plurality of inductor conductor layers 82, the specific second conductor layer 62, and the plurality of inductor conductor layers 83 are arranged in this order along the X direction. The dimension of the specific second conductor layer 62 in the second direction (the Y direction) orthogonal to each of the stacking direction and the first direction (the X direction) may be larger than the dimension of the opening surrounded by each of the plurality of inductor conductor layers 82 in the second direction (the dimension in the Y direction) and the dimension of the opening surrounded by each of the plurality of inductor conductor layers 83 in the second direction (the dimension in the Y direction).

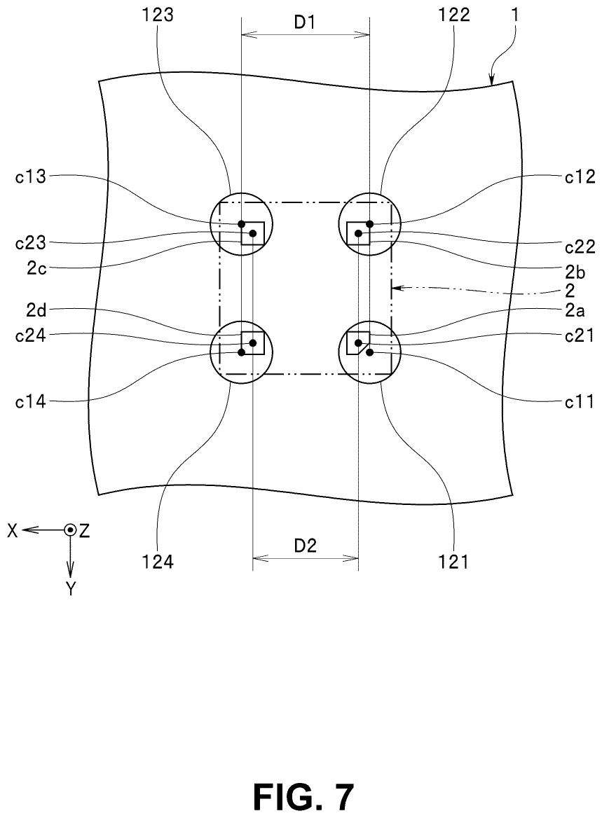

Next, features of the first to fourth electrode pads 121 to 124 of the first main body 1 and the first to fourth terminals 2a to 2d of the second main body 2 will be described with reference to FIG. 7. FIG. 7 is a plan view showing the first to fourth electrode pads 121 to 124 and the first to fourth terminals 2a to 2d.

In FIG. 7, the reference sign c11 indicates a center of the shape of the first electrode pad 121 when seen in the stacking direction (the direction parallel to the Z direction), that is, a center of the planar shape of the first electrode pad 121. The center c11 of the planar shape of the first electrode pad 121 may be a center of a circumscribed circle (circumcenter) of the planar shape of the first electrode pad 121, a center of an inscribed circle (incenter) of the planar shape of the first electrode pad 121, or a center of gravity of the planar shape of the first electrode pad 121.

Hereinafter, the center of the circumscribed circle of the planar shape of the first electrode pad 121 is defined as the center c11 of the planar shape of the first electrode pad 121. In the example shown in FIG. 7, the planar shape of the first electrode pad 121 is circular. Therefore, the center c11 matches the center of the planar shape (the center of the circle) of the first electrode pad 121. In the following description, the center c11 is referred to as the center of the first electrode pad 121 for convenience. For the second to fourth electrode pads 122 to 124 and the first to fourth terminals 2a to 2d, the center of the circumscribed circle of the shape when seen in the stacking direction, that is, the center of the circumscribed circle of the planar shape will be referred to simply as the center, as in the case of the first electrode pad 121.

The reference sign c12 indicates a center of the second electrode pad 122, the reference sign c13 indicates a center of the third electrode pad 123, and the reference sign c14 indicates a center of the fourth electrode pad 124. In addition, the reference sign c21 indicates a center of the first terminal 2a, the reference sign c22 indicates a center of the second terminal 2b, the reference sign c23 indicates a center of the third terminal 2c, and the reference sign c24 indicates a center of the fourth terminal 2d.

A distance between the centers of any given two electrode pads of the first to fourth electrode pads 121 to 124 is indicated by the symbol D1. In FIG. 7, a distance between the center c11 and the center c14 and a distance between the center c12 and the center c13 are indicated using the symbol D1. FIG. 7 shows a case where the distance between the center c11 and the center c14 is equal to the distance between the center c12 and the center c13.

In addition, a distance between the centers of any given two terminals of the first to fourth terminals 2a to 2d is indicated by the symbol D2. In FIG. 7, a distance between the center c21 and the center c24 and a distance between the center c22 and the center c23 are indicated using the symbol D2. FIG. 7 shows a case where the distance between the center c21 and the center c24 is equal to the distance between the center c22 and the center c23.

Now, focus is placed on any given two electrode pads adjacent to each other at a distance of the first to fourth electrode pads 121 to 124 and two terminals of the first to fourth terminals 2a to 2d, the two terminals being connected to the above two electrode pads, respectively. The distance D1 between the centers of the above two electrode pads is greater than the distance D2 between the centers of the above two terminals.

As described above, the first electrode pad 121, the second electrode pad 122, the first terminal 2a, and the second terminal 2b are connected to the first signal terminal 1b. The third electrode pad 123, the fourth electrode pad 124, the third terminal 2c, and the fourth terminal 2d are connected to the second signal terminal 1c. The length of a path from the first signal terminal 1b to the second signal terminal 1c is greater than the length of a path in the case where the distance D1 between the centers of the above two electrode pads is equal to the distance D2 between the centers of the above two terminals.

In the example embodiment, in particular, all combinations of two electrode pads of the first to fourth electrode pads 121 to 124 satisfy the requirement that the distance D1 between the centers of two electrode pads is greater than the distance D2 between centers of two terminals connected to the two electrode pads respectively. In other words, the distance D1 between the center c11 of the first electrode pad 121 and the center c12 of the second electrode pad 122 is greater than the distance D2 between the center c21 of the first terminal 2a and the center c22 of the second terminal 2b. The distance D1 between the center c12 of the second electrode pad 122 and the center c13 of the third electrode pad 123 is greater than the distance D2 between the center c22 of the second terminal 2b and the center c23 of the third terminal 2c. The distance D1 between the center c13 of the third electrode pad 123 and the center c14 of the fourth electrode pad 124 is greater than the distance D2 between the center c23 of the third terminal 2c and the center c24 of the fourth terminal 2d. The distance D1 between the center c14 of the fourth electrode pad 124 and the center c11 of the first electrode pad 121 is greater than the distance D2 between the center c24 of the fourth terminal 2d and the center c21 of the first terminal 2a.

In addition, the distance D1 between the center c11 of the first electrode pad 121 and the center c13 of the third electrode pad 123 is greater than the distance D2 between the center c21 of the first terminal 2a and the center c23 of the third terminal 2c. The distance D1 between the center c12 of the second electrode pad 122 and the center c14 of the fourth electrode pad 124 is greater than the distance D2 between the center c22 of the second terminal 2b and the center c24 of the fourth terminal 2d.

The length of the path from the first signal terminal 1b to the second signal terminal 1c is greater than the length of a path in a case where the distance D1 between the centers of the first electrode pad 121 and the second electrode pad 122 is equal to the distance D2 between the centers of the first terminal 2a and the second terminal 2b, and the distance D1 between the centers of the third electrode pad 123 and the fourth electrode pad 124 is equal to the distance D2 between the centers of the third terminal 2c and the fourth terminal 2d.

Next, the planar shapes (the shapes when seen in the stacking direction) of the first to fourth electrode pads 121 to 124 and the first to fourth terminals 2a to 2d will be described with reference to FIG. 7. The planar shapes of the first to fourth electrode pads 121 to 124 may be similar to or dissimilar to the planar shapes of the first to fourth terminals 2a to 2d, respectively. In the example embodiment, in particular, the shapes of the first to fourth electrode pads 121 to 124 are different from the planar shapes of the first to fourth terminals 2a to 2d, respectively. Specifically, the planar shape of each of the first to fourth electrode pads 121 to 124 is circular, the planar shape of the first terminal 2a is polygonal (pentagonal in the example shown in FIG. 7), and the planar shape of each of the second to fourth terminals 2b to 2d is rectangular.

In addition, the planar shapes of the first to fourth terminals 2a to 2d may be similar to or dissimilar to each other. In the example embodiment, in particular, the planar shapes (rectangle) of the second to fourth terminals 2b to 2d are different from the planar shape (polygon) of the first terminal 2a. The first terminal 2a may be used as a mark for confirming an orientation of the second main body 2.

Next, the operation and effects of the electronic component 100 according to the example embodiment will be described. The electronic component 100 according to the example embodiment includes the first main body 1 including the first and second circuit sections 10 and 20, and the second main body 2 mounted on the first main body 1 and including the first and second sub-circuit sections 41 and 42. The first main body 1 further includes the first to fourth electrode pads 121 to 124. The second main body 2 further includes the first to fourth terminals 2a to 2d. The first circuit section 10 is connected to the first and second electrode pads 121 and 122. The second circuit section 20 is connected to the third and fourth electrode pads 123 and 124. The first sub-circuit section 41 is connected to the first and second terminals 2a and 2b. The second sub-circuit section 42 is connected to the third and fourth terminals 2c and 2d.

In the example embodiment, as described above, the distance D1 between the centers of two electrode pads is greater than the distance D2 between the centers of two terminals connected to the two electrode pads respectively. Thus, according to the example embodiment, occurrences of unintended coupling and floating capacitance can be suppressed, and as a result, the desired characteristics can be achieved while downsizing the electronic component 100.

The effects of the electronic component 100 according to the example embodiment will now be described in more detail. First, the first electrode pad 121, the second electrode pad 122, the first terminal 2a, and the second terminal 2b will be described. In the example embodiment, the distance D1 between the center c11 of the first electrode pad 121 and the center c12 of the second electrode pad 122 is greater than the distance D2 between the center c21 of the first terminal 2a and the center c22 of the second terminal 2b. According to the example embodiment, when comparing with a case where the distance D1 between the center c11 and the center c12 is equal to the distance D2 between the center c21 and the center c22, with the distance D2 between the center c21 and the center c22 remaining the same distance, a distance between the through hole T1 connected to the first electrode pad 121 and the through hole T2 connected to the second electrode pad 122 can be increased. As a result, according to the example embodiment, the floating capacitance occurred between the through hole T1 and the through hole T2 can be suppressed.

In particular, when the first sub-circuit section 41 connected to the first and second terminals 2a and 2b is an acoustic wave resonator, self-resonance occurs due to the floating capacitance occurred between the through hole T1 and the through hole T2. According to the example embodiment, self-resonance can be suppressed by suppressing the floating capacitance as described above. Thus, according to the example embodiment, the desired characteristics can be achieved.

In addition, according to the example embodiment, when comparing with the case where the distance D1 between the center c11 and the center c12 is equal to the distance D2 between the center c21 and the center c22, with the distance D2 between the center c21 and the center c22 remaining the same distance, the length of the path from the first signal terminal 1b to the second signal terminal 1c can be increased. Thus, according to the example embodiment, deterioration of isolation characteristics between the first filter 4 and the second filter 5 can be suppressed.

The above description of the first electrode pad 121, the second electrode pad 122, the first terminal 2a, and the second terminal 2b also applies to the third electrode pad 123, the fourth electrode pad 124, the third terminal 2c, and the fourth terminal 2d. In other words, according to the example embodiment, a distance between the through hole T3 connected to the third electrode pad 123 and the through hole T4 connected to the fourth electrode 124 can be increased. As a result, according to the example embodiment, the floating capacitance to be occurred between the through hole T3 and the through hole T4 can be suppressed. In addition, according to the example embodiment, the length of the path from the first signal terminal 1b to the second signal terminal 1c can be increased, and deterioration of the isolation characteristics between the first filter 4 and the second filter 5 can be suppressed.

Next, the first electrode pad 121, the fourth electrode pad 124, the first terminal 2a, and the fourth terminal 2d will be described. In the example embodiment, the distance D1 between the center c11 of the first electrode pad 121 and the center c14 of the fourth electrode pad 124 is greater than the distance D2 between the center c21 of the first terminal 2a and the center c24 of the fourth terminal 2d. According to the example embodiment, when comparing with a case where the distance D1 between the center c11 and the center c14 is equal to the distance D2 between the center c21 and the center c24, with the distance D2 between the center c21 and the center c24 remaining the same distance, the distance between the through hole T1 connected to the first electrode pad 121 and the through hole T4 connected to the fourth electrode pad 124 can be increased. As a result, according to the example embodiment, the floating capacitance to be occurred between the through hole T1 and the through hole T4 can be suppressed, and coupling of the through hole T1 and the through hole T4 can be suppressed. Thus, according to the example embodiment, coupling of the first sub-circuit section 41 and the second sub-circuit section 42 via the through holes T1 and T4 or an element connected to the through holes T1 and T4 can be suppressed. Thus, according to the example embodiment, deterioration of the isolation characteristics between the first filter 4 and the second filter 5 can be suppressed.

The above description of the first electrode pad 121, the fourth electrode pad 124, the first terminal 2a, and the fourth terminal 2d also applies to a group of the second electrode pad 122, the third electrode pad 123, the second terminal 2b and the third terminal 2c, a group of the first electrode pad 121, the third electrode pad 123, the first terminal 2a, and the third terminal 2c, and a group of the second electrode 122, the fourth electrode pad 124, the second terminal 2b, and the fourth terminal 2d. In other words, according to the example embodiment, a distance between the through hole T2 connected to the second electrode pad 122 and the through hole T3 connected to the third electrode pad 123 can be increased. As a result, according to the example embodiment, floating capacitance to be occurred between the through hole T2 and the through hole T3 can be suppressed, and coupling of the through hole T2 and the through hole T3 can be suppressed. Thus, according to the example embodiment, coupling of the first sub-circuit section 41 and the second sub-circuit section 42 via the through holes T2 and T3 or an element connected to the through holes T2 and T3 can be suppressed.

Similarly, according to the example embodiment, coupling of the first sub-circuit section 41 and the second sub-circuit section 42 via the through holes T1 and T3 or an element connected to the through holes T1 and T3, and coupling of the first sub-circuit section 41 and the sub-circuit section 42 via the through holes T2 and T4 or an element connected to the through holes T2 and T4 can be suppressed. From above, according to the example embodiment, deterioration of the isolation characteristics between the first filter 4 and the second filter 5 can be suppressed.

Next, a result of a simulation examining isolation characteristics of the electronic component 100 according to the example embodiment will be described. A model of an example used in the simulation will initially be described. The model of the example is a model of the electronic component 100 according to the example embodiment. In the simulation, the first circuit section 10 and the first sub-circuit section 41 of the first filter 4, the second circuit section 20 and the second sub-circuit section 42 of the second filter 5, and the third circuit section 30 of the third filter 6 were designed to make the model of the example operate as a branching filter. In addition, in the simulation, the first to third filters 4 to 6 were designed such that a passband of the first filter 4 becomes 3.300 to 5.000 GHz, a passband of the second filter 5 becomes 5.150 to 7.125 GHz, and a passband of the third filter 6 becomes 0.698 to 2.690 GHz.

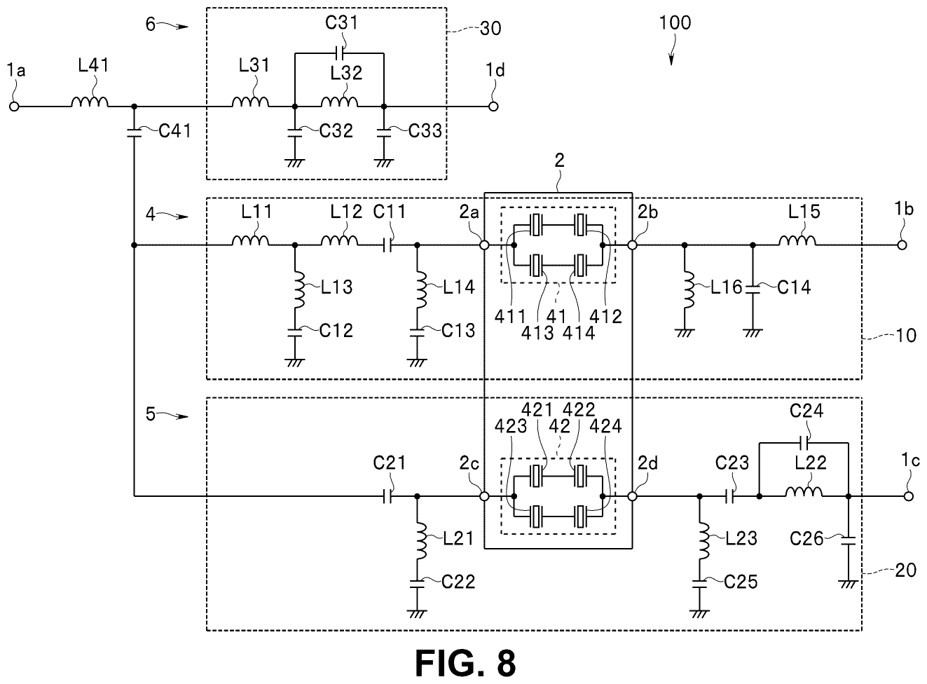

FIG. 8 is a circuit diagram showing a circuit configuration of the model of the example. The model of the example includes an inductor L41 and a capacitor C41 in addition to the first to third filters 4 to 6. One end of the inductor L41 is connected to the common terminal 1a. One ends of the third filter 6 and the capacitor C41 are connected to the other end of the inductor L41. The other end of the third filter 6 is connected to the third signal terminal 1d.

One ends of the first filter 4 and the second filter 5 are connected to the other end of the capacitor C41. The other end of the first filter 4 is connected to the first signal terminal 1b. The other end of the second filter 5 is connected to the second signal terminal 1c.

The third circuit section 30 of the third filter 6 includes inductors L31 and L32, and capacitors C31, C32, and C33. One end of the inductor L31 is connected to the other end of the inductor L41. One end of the inductor L32 is connected to the other end of the inductor L31. The other end of the inductor L32 is connected to the third signal terminal 1d.

The capacitor C31 is connected in parallel to the inductor L32. One end of the capacitor C32 is connected to a connection point of the inductor L31 and the inductor L32. One end of the capacitor C33 is connected to the other end of the inductor L32. The other ends of the capacitors C32 and C33 are connected to the ground.

The first circuit section 10 of the first filter 4 includes inductors L11, L12, L13, L14, L15, and L16, and capacitors C11, C12, C13, and C14. The first sub-circuit section 41 of the first filter 4 includes four acoustic wave elements 411, 412, 413, and 414.

One end of the inductor L11 is connected to the other end of the capacitor C41. One end of the inductor L12 is connected to the other end of the inductor L11. One end of the capacitor C11 is connected to the other end of the inductor L12. The other end of the capacitor C11 is connected to the first terminal 2a of the second main body 2.

One end of the inductor L13 is connected to a connection point of the inductor L11 and the inductor L12. One end of the capacitor C12 is connected to the other end of the inductor L13. The other end of the capacitor C12 is connected to the ground.

One end of the inductor L14 is connected to the other end of the capacitor C11 and the first terminal 2a of the second main body 2. One end of the capacitor C13 is connected to the other end of the inductor L14. The other end of the capacitor C13 is connected to the ground.

One ends of the acoustic wave elements 411 and 413 are connected to the first terminal 2a. One end of the acoustic wave element 412 is connected to the other end of the acoustic wave element 411. One end of the acoustic wave element 414 is connected to the other end of the acoustic wave element 413. The other ends of the acoustic wave elements 412 and 414 are connected to the second terminal 2b of the second main body 2.

One ends of the inductors L15 and L16 are connected to the second terminal 2b. The other end of the inductor L15 is connected to the first signal terminal 1b. The other end of the inductor L16 is connected to the ground.

One end of the capacitor C14 is connected to one end of the inductor L15. The other end of the capacitor C14 is connected to the ground.

The second circuit section 20 of the second filter 5 includes inductors L21, L22, and L23, and capacitors C21, C22, C23, C24, C25, and C26. The second sub-circuit section 42 of the second filter 5 includes four acoustic wave elements 421, 422, 423, and 424.

One end of the capacitor C21 is connected to the other end of the capacitor C41. The other end of the capacitor C21 and one end of the inductor L21 are connected to the third terminal 2c of the second main body 2. One end of the capacitor C22 is connected to the other end of the inductor L21. The other end of the capacitor C22 is connected to the ground.

One ends of the acoustic wave elements 421 and 423 are connected to the third terminal 2c. One end of the acoustic wave element 422 is connected to the other end of the acoustic wave element 421. One end of the acoustic wave element 424 is connected to the other end of the acoustic wave element 423. The other ends of the acoustic wave elements 422 and 424 are connected the fourth terminal 2d of the second main body 2.

One ends of the capacitor C23 and the inductor L23 are connected to the fourth terminal 2d. One end of the inductor L22 is connected to the other end of the capacitor C23. The other end of the inductor L22 is connected to the second signal terminal 1c. The capacitor C24 is connected in parallel to the inductor L22.

One end of the capacitor C25 is connected to the other end of the inductor L23. The other end of the capacitor C25 is connected to the ground.

One end of the capacitor C26 is connected to the other end of the inductor L22. The other end of the capacitor C26 is connected to the ground.

The plurality of inductors and the plurality of capacitors shown in FIG. 8 are configured using the plurality of dielectric layers, the plurality of conductor layers, and the plurality of through holes of the stack 50.

Note that the inductor L14 and the inductor L16 may correspond respectively to the “inductor L1” and the “inductor L2” shown in FIG. 5 and FIG. 6. In this case, the capacitor C13 may correspond to the “capacitor C1”shown in FIG. 5 and FIG. 6.

In addition, the inductor L21 and the inductor L23 may correspond respectively to the “inductor L3” and the “inductor L4” shown in FIG. 5 and FIG. 6. In this case, the capacitor C25 may correspond to the “capacitor C2”shown in FIG. 5 and FIG. 6.

Next, a model of a comparative example used in the simulation will be described. The model of the comparative example is a model of an electronic component of the comparative example. The circuit configuration of the model of the electronic component of the comparative example is the same as the circuit configuration of the model of the example shown in FIG. 8. In addition, the electronic component of the comparative example includes a first main body 101 instead of the first main body 1 in the example embodiment. A configuration of the first main body 101 is basically the same as the configuration of the first main body 1 in the example embodiment. However, the model of the electronic component of the comparative example is different from the model of the example in the layout of the first to fourth electrode pads 121 to 124.

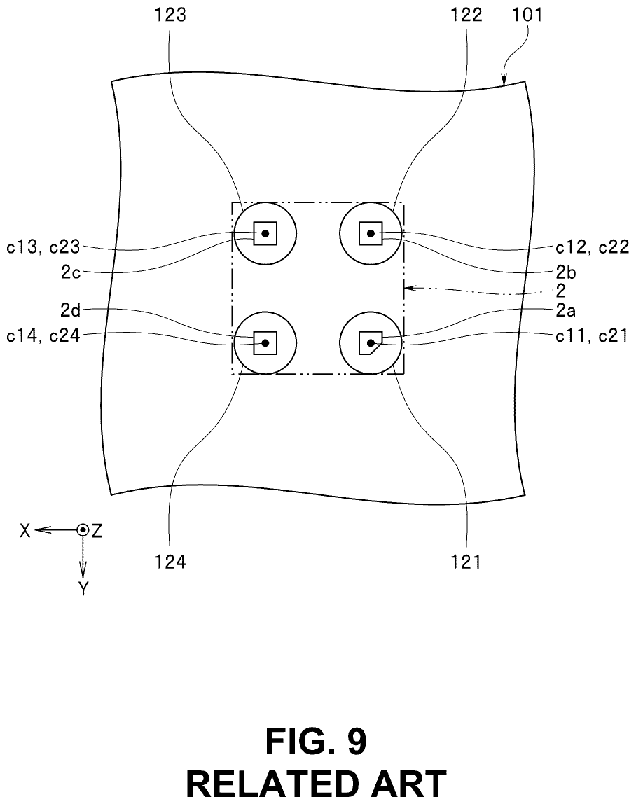

FIG. 9 is a plan view showing the first to fourth electrode pads 121 to 124 and the first to fourth terminals 2a to 2d in the electronic component of the comparative example. In the model of the electronic component of the comparative example, the distance D1 between the centers of any given two electrode pads adjacent to each other at a distance of the first to fourth electrode pads 121 to 124 is equal to the distance D2 between the centers of two terminals of the first to fourth terminals 2a to 2d, the two terminals being connected to the above two electronic pads, respectively.

In addition, in the model of the comparative example, the plurality of first conductor layers 61 of the first structure 8 are directly connected to the plurality of second conductor layers 62 of the second structure 9.

Next, the result of the simulation will be described. In the simulation, the model of the example and the model of the comparative example were each examined for the frequency characteristics of isolation between the first and second filters 4 and 5. Note that the isolation in the simulation is defined as follows. Suppose that when a high frequency signal of power P1 is input to the first signal terminal 1b, a signal of power P2 is output from the second signal terminal 1c. Isolation I is defined by the following Equation (1):

I=10 Log (P2/P1) (1)

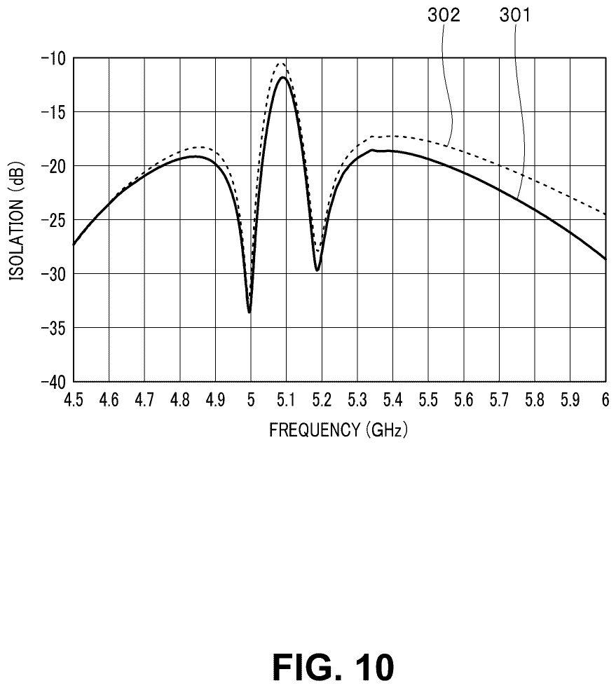

FIG. 10 is a characteristic chart showing the frequency characteristics of the isolation. In FIG. 10, the horizontal axis indicates the frequency, and the vertical axis indicates the isolation. In FIG. 10, the curve denoted by the reference sign 301 represents the frequency characteristics of the isolation of the model of the example. The curve denoted by the reference sign 302 represents the frequency characteristics of the isolation of the model of the comparative example. As seen from the result of the simulation, the model of the example (301) provides sufficient isolation characteristics for practical use. Note that as shown in FIG. 10, the model of the example (301) provides an isolation of a large absolute value compared to the model of the comparative example (302).

### Modification Examples

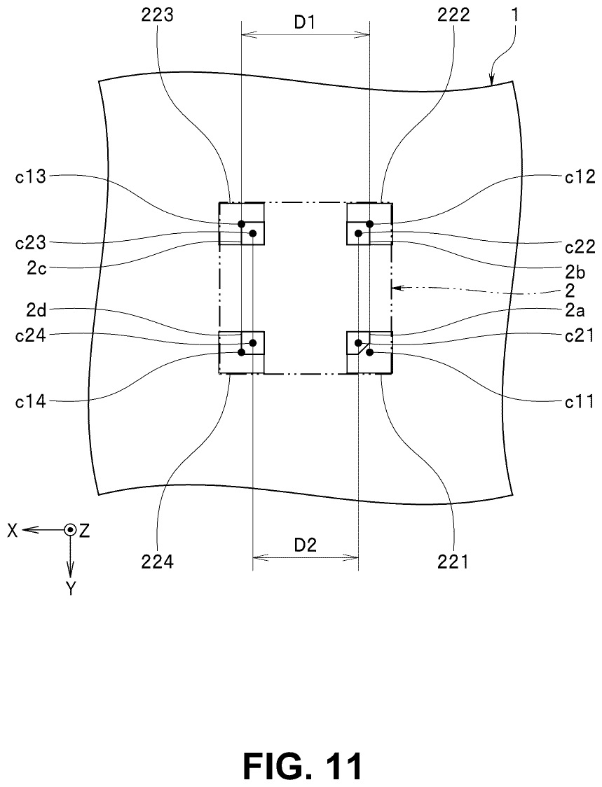

Next, first and second modification examples of the electronic component 100 according to the example embodiment will be described. The first modification example will initially described with reference to FIG. 11. FIG. 11 is a plan view showing first to fourth electrode pads 121 to 124 and first to fourth terminals 2a to 2d in the first modification example. In the first modification example, the shapes (the planar shapes) of the first to fourth electrode pads 121 to 124 when seen in the stacking direction (the direction parallel to the Z direction) are rectangular. In the first modification example, in particular, the planar shapes of the second to fourth electrode pads 122 to 124 are similar to the planar shapes of the second to fourth terminals 2b to 2d, respectively.

In the first modification example, a part of an outer edge of the planar shape of the first terminal 2a may match, or substantially match a part of an outer edge of the planar shape of the first electrode pad 121 when seen in the Z direction. Similarly, a part of an outer edge of the planar shape of the second terminal 2b may match or substantially match a part of an outer edge of the planar shape of the second electrode 122 when seen in the Z direction. A part of an outer edge of the planar shape of the third terminal 2c may match or substantially match a part of an outer edge of the planar shape of the third electrode pad 123 when seen in the Z direction. A part of an outer edge of the planar shape of the fourth terminal 2d may match or substantially match a part of an outer edge of the planar shape of the fourth electrode pad 124.

Note that in the example shown in FIG. 11, the planar shape of the first electrode pad 121 is not similar to the planar shape of the first terminal 2a. However, the planar shape of the first electrode pad 121 may be similar to the planar shape of the first terminal 2a.

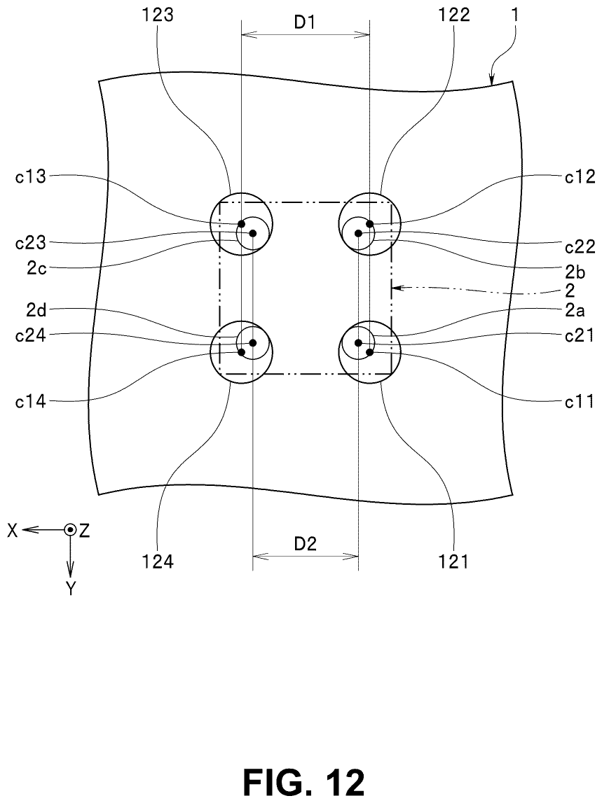

Next, the second modification example will be described with reference to FIG. 12. FIG. 12 is a plan view showing first to fourth electrode pads 121 to 124 and first to fourth terminals 2a to 2d in the second modification example. In the second modification example, the shapes (the planar shapes) of the first to fourth terminals 2a to 2d when seen in the stacking direction (the direction parallel to the Z direction) are circular. The planar shapes of the first to fourth electrode pads 121 to 124 are similar to the planar shapes of the first to fourth terminals 2a to 2d, respectively.

Note that similar to the first modification example shown in FIG. 11, the planar shape of the first electrode pad 121 do not have to be similar to the planar shape of the first terminal 2a.

Note that the disclosure is not limited to the foregoing example embodiment, and various modifications may be made thereto. For example, the electronic component of the disclosure may be a diplexer including two filters, or may be a band-pass filter including a plurality of filters.

In addition, the requirement that the distance D1 between the centers of two electrode pads is greater than the distance D2 between the centers of two terminals connected to the two electrode pads respectively may be satisfied by a part of the all combinations of two electrode pads of the first to fourth electrode pads 121 to 124. For example, only the combination of the first and second electrode pads 121 and 122 or the combination of the third and fourth electrode pads 123 and 124 may satisfy the above requirement. Alternatively, the combination of the first and second electrode pads 121 and 122 and the combination of the third and fourth electrode pads 123 and 124 may satisfy the above requirement and the other combinations do not have to satisfy the above requirement. Furthermore, the combination of the first and fourth electrode pads 121 and 124 and the combination of the second and third electrode pads 122 and 123 may satisfy the above requirement and the other combinations do not have to satisfy the above requirement.

Furthermore, when the planar shapes of the first to fourth electrode pads 121 to 124 are the shapes in the first modification example, the planar shapes of the first to fourth terminals 2a to 2d may be the shapes in the second modification example.

As described above, an electronic component according to one embodiment of the disclosure includes a first main body including a plurality of dielectric layers stacked together, and a circuit section; a second main body mounted on the first main body, and including a sub-circuit section; and a first filter including at least one of the circuit section or the sub-circuit section, and configured to selectively pass a signal of a frequency within a first passband. The first main body further includes a first surface and a second surface located at both ends of the plurality of dielectric layers in a stacking direction of the plurality of dielectric layers, and a plurality of electrode pads provided on the first surface. The second main body further includes a plurality of terminals provided on an outer surface of the second main body. The plurality of electrode pads include a first electrode pad and a second electrode pad. The plurality of terminals include a first terminal connected to the first electrode pad, and a second terminal connected to the second electrode pad. The circuit section is connected to the first electrode pad; and the sub-circuit section is connected to the second terminal. A distance between centers of the first electrode pad and the second electrode pad is greater than a distance between centers of the first terminal and the second terminal.

In the electronic component according to one embodiment of the disclosure, the first main body may further include a first signal terminal and a second signal terminal. The plurality of electrode pads may further include a third electrode pad and a fourth electrode pad. The plurality of terminals may further include a third terminal connected to the third electrode pad, and a fourth terminal connected to the fourth electrode pad. The first electrode pad, the second electrode pad, the first terminal, and the second terminal may be connected to the first signal terminal. The third electrode pad, the fourth electrode pad, the third terminal, and the fourth terminal may be connected to the second signal terminal.

In the electronic component according to one embodiment of the disclosure, a distance between centers of any given two electrode pads adjacent to each other at a distance of the plurality of electrode pads may be greater than a distance between centers of two terminals of the plurality of terminals, the two terminals being connected to the any given two electrode pads, respectively.

The electronic component according to one embodiment of the disclosure may further include a second filter configured to selectively pass a signal of a frequency within a second passband different from the first passband. The first filter may include the circuit section and the sub-circuit section. The first filter may be connected to the first signal terminal, and the second filter may be connected to the second signal terminal.

In the electronic component according to one embodiment of the disclosure, a length of a path from the first signal terminal to the second signal terminal may be greater than a length of the path when the distance between the centers of the first electrode pad and the second electrode pad is equal to the distance between the centers of the first terminal and the second terminal.

In the electronic component according to one embodiment of the disclosure, shapes of the plurality of electrode pads when seen in the stacking direction are circular.

In the electronic component according to one embodiment of the disclosure, shapes of the plurality of electrode pads when seen in the stacking direction may be similar to shapes of the plurality of terminals respectively when seen in the stacking direction.

In the electronic component according to one embodiment of the disclosure, the first main body may further include a plurality of through holes. The plurality of through holes may be connected to the plurality of electrode pads, respectively.

In the electronic component of the disclosure, the distance between the centers of the first electrode pad and the second electrode pad is greater than the distance between the centers of the first terminal and the second terminal. Thus, according to the disclosure, the desired characteristics can be achieved while downsizing the electronic component.

It is apparent that the disclosure can be carried out in various forms and modifications in the light of the foregoing descriptions. Accordingly, within the scope of the following claims and equivalents thereof, the disclosure can be carried out in forms other than the foregoing example embodiments.

1. An electronic component comprising:
a first main body including a plurality of dielectric layers stacked together, and a circuit section;
a second main body mounted on the first main body, and including a sub-circuit section; and
a first filter including at least one of the circuit section or the sub-circuit section, and configured to selectively pass a signal of a frequency within a first passband, wherein:
the first main body further includes a first surface and a second surface located at both ends of the plurality of dielectric layers in a stacking direction of the plurality of dielectric layers, and a plurality of electrode pads provided on the first surface;
the second main body further includes a plurality of terminals provided on an outer surface of the second main body;
the plurality of electrode pads include a first electrode pad and a second electrode pad;
the plurality of terminals include a first terminal connected to the first electrode pad, and a second terminal connected to the second electrode pad;
the circuit section is connected to the first electrode pad;
the sub-circuit section is connected to the second terminal; and
a distance between centers of the first electrode pad and the second electrode pad is greater than a distance between centers of the first terminal and the second terminal.

2. The electronic component according to claim 1, wherein:
the first main body further includes a first signal terminal and a second signal terminal;
the plurality of electrode pads further include a third electrode pad and a fourth electrode pad;
the plurality of terminals further include a third terminal connected to the third electrode pad, and a fourth terminal connected to the fourth electrode pad;
the first electrode pad, the second electrode pad, the first terminal, and the second terminal are connected to the first signal terminal; and
the third electrode pad, the fourth electrode pad, the third terminal, and the fourth terminal are connected to the second signal terminal.

3. The electronic component according to claim 2, wherein a distance between centers of any given two electrode pads adjacent to each other at a distance of the plurality of electrode pads is greater than a distance between centers of two terminals of the plurality of terminals, the two terminals being connected to the any given two electrode pads, respectively.

4. The electronic component according to claim 2, further comprising:
a second filter configured to selectively pass a signal of a frequency within a second passband different from the first passband, wherein:
the first filter includes the circuit section and the sub-circuit section;
the first filter is connected to the first signal terminal; and
the second filter is connected to the second signal terminal.

5. The electronic component according to claim 2, wherein a length of a path from the first signal terminal to the second signal terminal is greater than a length of the path when the distance between the centers of the first electrode pad and the second electrode pad is equal to the distance between the centers of the first terminal and the second terminal.

6. The electronic component according to claim 1 wherein shapes of the plurality of electrode pads when seen in the stacking direction are circular.

7. The electronic component according to claim 1 wherein shapes of the plurality of electrode pads when seen in the stacking direction are similar to shapes of the plurality of terminals respectively when seen in the stacking direction.

8. The electronic component according to claim 1, wherein:
the first main body further includes a plurality of through holes; and
the plurality of through holes are connected to the plurality of electrode pads, respectively.
